(19) United States
(12) Patent Application Publication
(10) Pub. No.: US 2009/0112743 A1
(43) Pub. Date: Apr. 30, 2009

(54) SYSTEM AND METHOD FOR REPORTING ACCORDING TO EU VAT RELATED LEGAL REQUIREMENTS

(76) Inventors: Christine M. Mullins, Vestal, NY (US); Scotty J. Reynolds, Binghamton, NY (US); Daniel A. Schofield, Endicott, NY (US)

Correspondence Address: HOFFMAN WARNICK LLC, 75 STATE ST, 14TH FLOOR, ALBANY, NY, 12207, US

(21) Appl. No.: 11/932,055

(22) Filed: Oct. 31, 2007

(51) Int. Cl. G06Q 40/00; G06F 17/30; G06F 19/00

(52) U.S. Cl. 705/31; 705/30

(57) ABSTRACT

A system and method for reporting according to the EU VAT related legal requirements and, in the preferred embodiment, within SAP environment is described. Because the report will aid in legally required reporting for EU VAT, it will also aid in the avoidance of penalties that may be legally imposed for non-compliance to EU VAT rules. This invention will also allow for better reporting and improved EU VAT Reclamation process. The present invention provides for data collection of EU VAT related invoice transactions made electronically based on additional fields which are provided in SAP. Additionally, a new report is created and is run based on input criteria.

### CROSS-REFERENCE TO RELATED APPLICATION

This application is related in some aspects to commonly owned and co-pending patent application Ser. No. 11/408,913, entitled “METHOD, SYSTEM, AND PROGRAM PRODUCT FOR ELECTRONICALLY VALIDATING INVOICES”, assigned attorney docket number END920060029US1, filed Apr. 21, 2006, the entire contents of which are herein incorporated by reference.

### BACKGROUND OF THE INVENTION

1. Field of the Invention

The present invention generally relates to the legally required reporting of EU VAT and, more specifically, the present invention provides a system and method for reporting according to the EU VAT related legal requirements within SAP in an improved manner.

2. Related Art

There presently is a problem in the EU VAT reclamation process. As a matter of background, the European Union (EU) is a unique political and economic community with supranational and intergovernmental dimensions. It is composed of twenty-seven member states primarily located in Europe. Value added tax (VAT), or goods and services tax (GST), is tax on exchanges. It is levied on the added value that results from each exchange. It differs from a sales tax because a sales tax is levied on the total value of the exchange. For this reason, a VAT is neutral with respect to the number of passages that there are between the producer and the final consumer. To get a refund, companies must send receipts and paperwork to the appropriate VAT authorities in each country. The paperwork must be filled out in the official language of that nation, meeting deadlines that are based either on the calendar year or the fiscal calendar. Then there is the variation on the VAT rates themselves. The amount of tax varies from country to country and from item to item, from as low as 3 percent to as high as 25 percent. Some countries refund VAT on hotel rooms but not car rentals (Austria), and some refund VAT on car rentals but not hotel rooms (Belgium). Germany refunds the 15 percent tax on everything, while Italy and Portugal only refund fees for conferences. Switzerland allows a purchaser to reclaim nothing.

Managing the VAT reclamation process is so daunting that many of U.S. companies have some sort of reclamation organized process in place. It is further a problem with the present art with legally required reporting of EU VAT within SAP software which is a popular enterprise software program. The SAP ERP application is an integrated enterprise resource planning (ERP) software manufactured by SAP AG that targets business software requirements of midsize and large organizations in all industries and sectors. It is the successor product to SAP R/3. There are legal reporting requirements for EU VAT and, if the EU VAT is not properly reported and, therefore the SAP user is in non-compliance with EU VAT rules, penalties are incurred. There is a need for a report which will aid in legally required reporting for EU VAT and which will also aid in the avoidance of penalties that may be legally imposed for non-compliance to EU VAT rules. There is a need for a tool to allow for better reporting and improved EU VAT Reclamation process.

The EU Invoicing directive allows each member state of the EU to decide if it requires a protocol report. If an individual country decides it needs a protocol report, it must be enacted in that individual country's law. Currently, Hungary, Germany and the Netherlands require protocol reports. The EU directive relating to this reporting requirement is the Council Directive 2001/115/EC and may be found here: http://eur-lex.europa.eu/smartapi/cgi/sga_doc?smartapi!celexgpi!prod!CLEXnumdoc&numdoc=3 2001,L0115&model=guihett&lg=en.

Present systems have the user manually querying the SAP database for known suppliers' invoices. From that list, user manually searches the raw data submitted by the supplier for each invoice, so that the supplier tax country and purchasing tax country can be found and reports can be generated for the EU member countries requiring such reports. However, these systems have drawbacks such as personnel costs and human error in locating all invoices across multiple data files.

Therefore, there exists a need for a solution that solves at least one of the deficiencies of the related art.

### SUMMARY OF THE INVENTION

In general, the present invention provides a system and method for reporting according to the EU VAT related legal requirements and, in the preferred embodiment, within SAP environment. Because the report will aid in legally required reporting for EU VAT, it will also aid in the avoidance of penalties that may be legally imposed for non-compliance to EU VAT rules. This invention will also allow for better reporting and improved EU VAT Reclamation process.

The present invention provides for data collection of EU VAT related invoice transactions made electronically based on additional fields which are provided in SAP. Additionally, a new report is created and is run based on input criteria which include the following additional fields:
Supplier VAT Registration number;
Supplier Tax Country;
Purchasing VAT Registration number;
Purchasing Tax Country;
Tax Amount in Local Currency;
Local Currency Code; and
Invoice/Tax Point Date.

The advantages of using a system generated report are:
Increased accuracy in reporting by minimizing the possibility of human error;
Decreased personnel costs; and
Lower possibility for penalties and interest that may be assessed for inaccurate reporting.

The present invention also provides related methods and/or program products. Such methods and program products would provide a way to enable a user to generate a report from SAP.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a system, for suitable for storing and/or executing program code, such as the program code of the present invention.

FIG. 2 shows an illustrative communication network for implementing the method of the present invention.

FIG. 3 shows a sample protocol report template according to the present invention.

FIG. 4 illustrates an example of an input selection criteria for SAP electronic invoice VAT report according to the present invention.

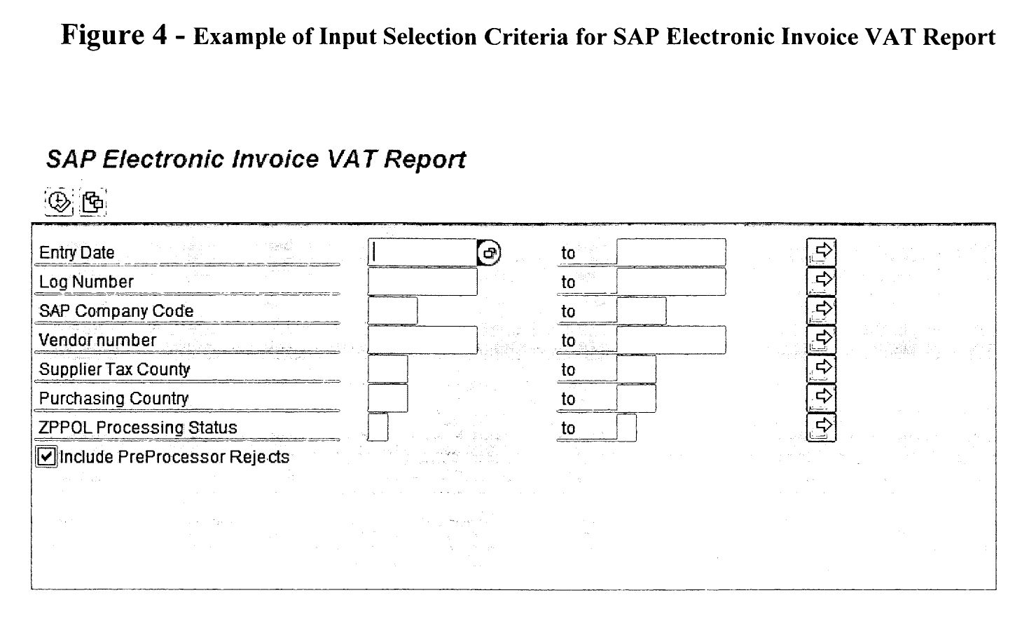

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

The present invention provides a way to enable a user to generate a report from SAP.

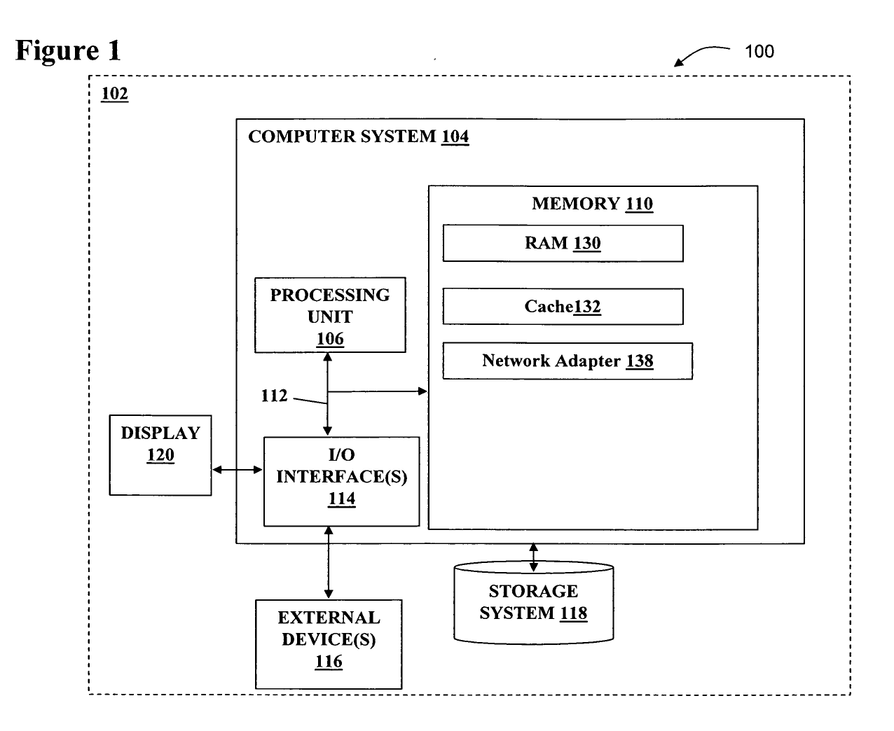

A data processing system, such as that system 100 shown in FIG. 1, suitable for storing and/or executing program code, such as the program code of the present invention, will include at least one processor (processing unit 106) coupled directly or indirectly to memory elements through a system bus. The memory elements can include local memory (RAM 130) employed during actual execution of the program code, bulk storage (storage 118), and cache memories (cache 132) which provide temporary storage of at least some program code in order to reduce the number of times code must be retrieved from bulk storage during execution. Input/output or IPO devices (external devices 116) (including but not limited to keyboards, displays, pointing devices, etc.) can be coupled to the system either directly or through intervening I/O controllers (I/O Interface 114).

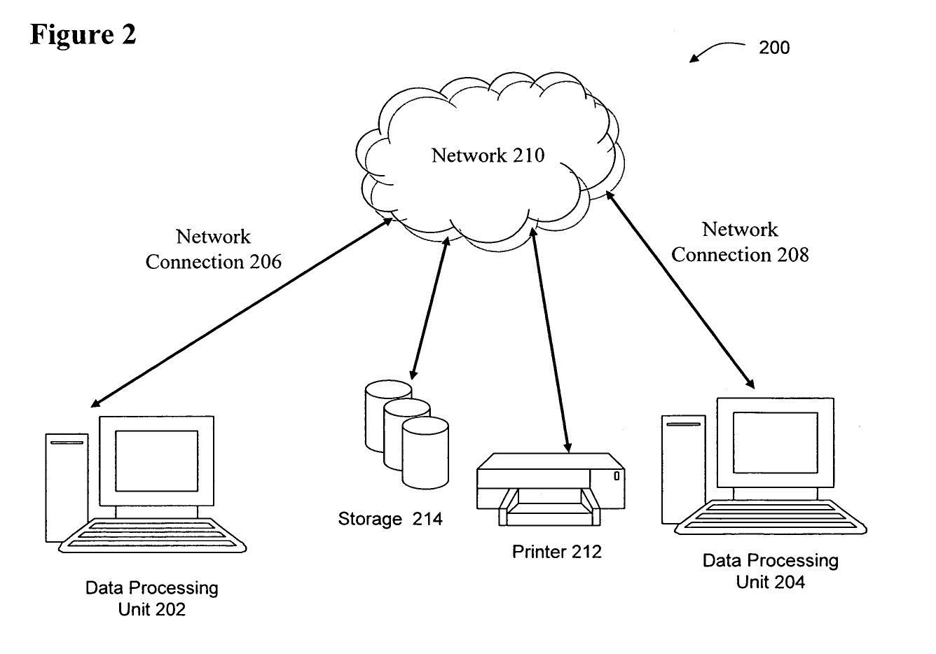

Network adapters (network adapter 138) may also be coupled to the system to enable the data processing system (as shown in FIG. 2, data processing unit 102) to become coupled to other data processing systems (data processing unit 204) or remote printers (printer 212) or storage devices (storage 214) through intervening private or public networks (network 210). (A computer network is composed of multiple computers connected together using a telecommunication system for the purpose of sharing data, resources and communication. For more information, see http://historyoftheinternet.org/). Modems, cable modem and Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

In general, the present invention provides a system and method for reporting information according to the EU VAT related legal requirements and, in the preferred embodiment, within SAP environment. Because the report will aid in legally required reporting for EU VAT, it will also aid in the avoidance of penalties that may be legally imposed for non-compliance to EU VAT rules. This invention will also allow for better reporting and an improved EU VAT reclamation process.

The present invention provides for data collection of EU VAT related invoice transactions made between a supplier and a purchaser, the invoice transactions being made electronically and include additional fields which are provided in SAP. Additionally, a new report is created and is run based on input criteria which include the following additional fields:
Supplier VAT Registration number;
Supplier Tax Country;
Purchasing VAT Registration number;
Purchasing Tax Country;
Tax Amount in Local Currency;
Local Currency Code; and
Invoice/Tax Point Date.

The advantages of using a system generated report are:
Increased accuracy in reporting by minimizing the possibility of human error;
Decreased personnel costs; and
Lower possibility for penalties and interest that may be assessed for inaccurate reporting.

The present invention also provides related methods and/or program products. Such methods and program products would provide a way to enable a user to generate a report from SAP.

A protocol report contains the following information:
Supplier (or Vendor) company name;
Supplier (or Vendor) address;
Supplier (or Vendor) Tax/VAT number;
Supplier (or Vendor) EU VAT number;
Purchasing company (in the present example, “IBM”) name;
Purchasing company address;
Purchasing company Tax/VAT number;
Purchasing company EU VAT number;
Reporting period;
Invoice number;
Invoice date;
Baseline date;
Invoice Net Amount;
VAT Rate;
Invoice VAT Amount;
Total Amount; and
Currency.

The protocol report is created by the supplier (or Vendor) and lists all electronic invoices submitted to Supplier for which a protocol report is required.

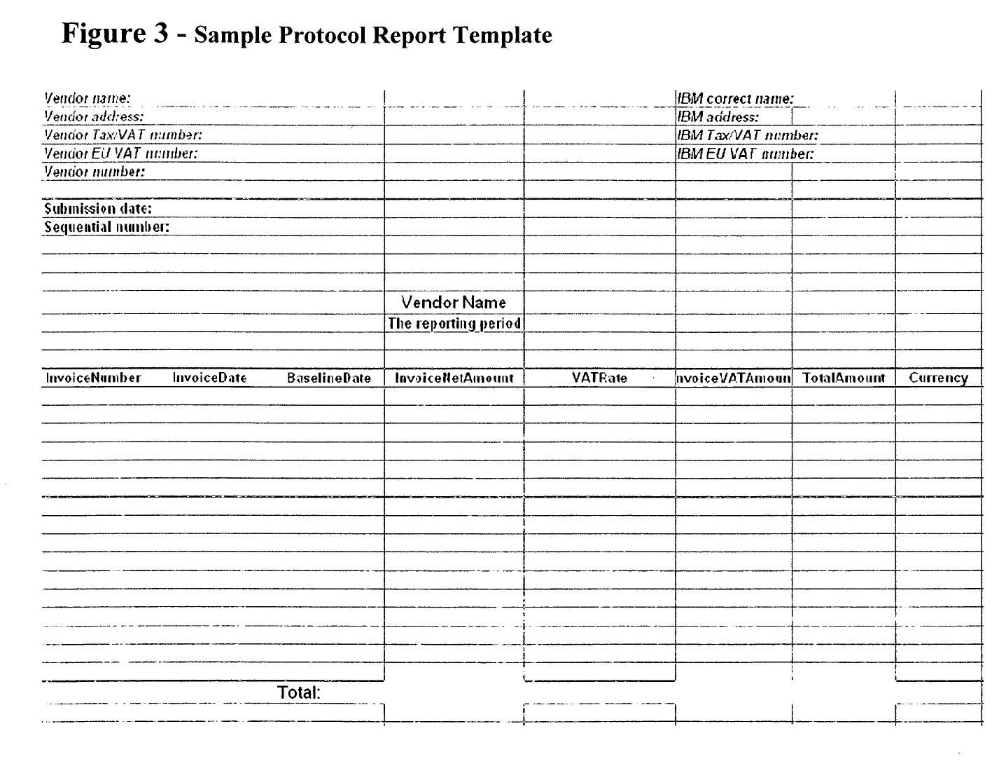

An example protocol report is shown in FIG. 3.

As noted above, FIG. 3 Sample Protocol Report Template comprises vendor information along the left hand side such as vendor name, vendor address, vendor tax VAT number, vendor EU VAT number and vendor name. It also includes along the right hand side purchaser (“IBM” in this example) such as purchaser name, purchaser address, purchaser tax VAT number, and purchaser EU VAT number. It further includes the reporting period, the invoice number, the invoice data, baseline date, the invoice net amount, VAT Rate, invoice VAT amount, total amount and currency.

The system needs to record information. This information is recorded in two custom SAP tables, ZPPAL (EDI810 audit log, inbound idocs) and ZPPOL (EDI810 invoice processing log).

In order to have a controlled process, the supplier provided protocol report must be reconciled to the electronic invoices received by the purchasing company's SAP system. This allows the purchasing company to recover VAT that is charged on an invoice. Additionally, proper reconciliation is required in order to prove that the purchasing company recovered only the appropriate taxes, and nothing more than is due. This allows the company to avoid the assessment of any legal penalties.

To perform the reconciliation, an SAP report is needed which lists all invoices for a given supplier and company code which meet the protocol report criteria.

The report will show the current invoice status as of the report run date. As the invoice status changes, the report output also changes.

As a result of the protocol report reconciliation, the invoices may be blocked for payment pending further investigation. If an invoice is not reported on a supplier protocol report within a predetermined window, the invoice will be returned to the supplier. The invoices will be reported to the appropriate team and the VAT reclamation process will ensue.

This report will not be limited to use for the Protocol Report Reconciliation and EU VAT reclamation for those countries requiring Protocol reports. The report will also be used for legal requirement for French Anomaly reporting.

ZPPAL Table

The ZPPAL table is a log of all inbound electronic idocs. The table contains data used in upfront validations that are performed by the custom SAP preprocessor program, Z810XX0. This table contains information for invoices that pass and fail the upfront validations.

The fields within the ZPPAL table are as follows:

| Field Name | Field Description |
|---|---|
| ZLGNO | LOG NUMBER FOR 810 EDI PREPROCESSOR |
| | PROGRAMs |
| ZSQNO | SEQUENCE NUMBER FOR 810 PREPROCESSOR |
| SNDPOR | Sender port (SAP System, EDI subsystem) |
| UNAME | User name |
| BELNR | Accounting document number |
| DATUM | Date |
| UZEIT | Time |
| SNDPRN | EDI SENDING PARTNER NUMBER |
| NAME1 | NAME FROM EDI_Z3 RS RECORD |
| VBELN | Vendor's Billing Invoice Number |
| SHKZG | Debit/credit indicator |
| ZOGIV | ORIGINAL GROSS AMOUNT FROM INVOICE |
| ZOTIV | ORIGINAL TAX AMOUNT FROM INVOICE |
| ZCGIV | IDOC GROSS INVOICE AMOUNT |
| ZCTIV | IDOC PROPORTIONED TAX AMOUNT |
| WAERS | Currency Key |
| ZNOID | NUMBER OF IDOCS CREATED |
| MSGID | Message identification |
| MSGTY | Message type |
| MSGNO | System message number |
| MTEXT | MESSAGE TEXT GENERATED DURING 810 |
| | PREPROCESSOR RUN |
| RCVPRN | Partner number of receiver |
| ZDATUM | Date |
| ZUZEIT | Time |
| ZUNAME | User name |
| SNDLAD | Logical address of sender |
| BUKRS | Company Code |
| EBELN | Purchasing Document Number |
| VAL_RULEID | EU VAT validation rule identifier |
| SUPTXLAND1 | Supplier ISO Country key |
| PUR_LAND1 | Purchasing ISO Country key |
| DEL_LAND1 | Ship to ISO Country key |
| REG_NUM906 | Supplier VAT registration number |
| REG_NUM909 | Purchasing company VAT registration number |
| REG_DOM906 | VAT registration number |

ZPPOL Table

The ZPPOL table is a log of those inbound electronic idocs that have passed through the first validation and are ready for posting within SAP.

The fields contained in the ZPPOL table are as follows:

| Field Name | Field Description |
|---|---|
| ZLGNO | LOG NUMBER FOR 810 EDI PREPROCESSOR |
| | PROGRAMs |
| ZSQNO | SEQUENCE NUMBER FOR 810 PREPROCESSOR |
| EBELN | Purchasing Document Number |
| DOCNUM | IDOC DOCUMENT NUMBER |
| ZIPRO | IDOC PROCESSED FLAG |
| BUKRS | Company Code |
| BELNR | Accounting document number |
| GJAHR | Fiscal year |
| ZDATE | Date |
| ZCGIV | IDOC GROSS INVOICE AMOUNT |
| ZCTIV | IDOC PROPORTIONED TAX AMOUNT |
| WAERS | Currency Key |
| ZDATUM | Date |
| ZUZEIT | Time |
| ZUNAME | User name |

Running the EU VAT Electronic Invoice Report Tool:

The report can be run based on the following input criteria:
Entry Date;
Log Number;
SAP Company Code;
Vendor number;
Supplier Tax Country (i.e., HU, NL, DE, FR);
Purchasing Tax Country (i.e., HU, NL, DE, FR);
ZPPOL Processing status (D, E, P, R, M, C)** (see Table 1); and
Flag to include/exclude preprocessor errors.
Processing Status Flag definitions

TABLE 1

| IDOC | |
|---|---|
| PROCESSED | |
| FLAG | Short text |
| D | Idoc not processed |
| E | Idoc failed to process |
| P | Idoc processed successfully |
| R | Idoc RTV'd due to expiration |
| M | Idoc RTV'd manually |
| C | Idoc cancelled from processing, NO RTV |

Example of Input Selection Criteria for SAP Electronic Invoice VAT Report

EU VAT Electronic Invoice Report Tool Output:

The information that is output on this report will include the following:
Company Code;
Vendor Number;
Vendor Name;
Supplier Tax Country;
Purchasing Tax Country;
Transaction Type (D=Debit, C=Credit);
Supplier Invoice Number;
Supplier Invoice Date (also called Tax Point Date);
SAP Document Number;
Year;
Invoice Baseline Date;
Gross Amount in Document Currency;
Document Currency Code;
Tax Amount in Document Currency;
Document Currency Code;
Tax Amount in Local Currency;
Local Currency Code;
Log Number;
Sequence Number;
Processing Date/Entry Date;
Purchase Order Number;
Invoice Processing Status;

The report is in a format that is easily exported to a spreadsheet application (Microsoft Excel®, IBM Lotus 1-2-3®, etc.).

Additionally, the report is interactive when logged onto SAP. The following fields can be drilled into:
SAP Document number;
Purchase Order number; and
Invoice processing status. This field will contain the Idoc number if the invoice has successfully passed the first round of validations. The Idoc number can be drilled into so that the Idoc details can be viewed.

It should be understood that the present invention is typically computer-implemented via hardware and/or software. As such, and client systems and/or servers will include computerized components as known in the art. Such components typically include (among others), a processing unit, a memory, a bus, input/output (I/O) interfaces, external devices, etc. It should also be understood that although a specific embodiment has been depicted and described, the present invention could be implemented in conjunction with any type of data processing system.

While shown and described herein as a system and method for provides a way to enable a user to generate a report from SAP, it is understood that the invention further provides various alternative embodiments. For example, in one embodiment, the invention provides a computer-readable/useable medium that includes computer program code to enable a computer infrastructure to provides a way to enable a user to generate a report from SAP. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In still another embodiment, the invention provides a computer-implemented method for archiving relational database data. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for collecting data related to EU VAT related invoice transactions made electronically based on additional fields which are created in SAP, the method comprising the steps of receiving the input criteria from the purchaser in the form an electronic invoice VAT report, parsing the input criteria, and creating a report for the purchaser.

2. A method for creating a report for a purchaser of products from a supplier in the EU which are assessed VAT and the purchaser wishes to reclaim the assessed VAT, the created report is based on input criteria related to EU VAT transactions, the input criteria are input electronically and includes the following fields:
supplier VAT registration number;
supplier tax country;
purchaser VAT registration number;
purchasing tax country;
tax amount in local currency;
local currency code; and
invoice/tax point date,
the method comprising the steps of receiving the input criteria from the purchaser in the form an electronic invoice VAT report, parsing the input criteria, and creating a report for the purchaser.

3. The method of claim 2 wherein the method is performed in a SAP system.

4. The method of claim 2 further including the step of validating that the report conforms to EU VAT reporting requirements.

5. The method of claim 4 further including the step of creating a log of all received input criteria.

6. The method of claim 5 wherein the log is stored in a ZPPAL table.

7. The method of claim 6 wherein the ZPPAL table includes the following fields:

| | |
|---|---|
| ZLGNO | LOG NUMBER FOR 810 EDI PREPROCESSOR |
| | PROGRAMs |
| ZSQNO | SEQUENCE NUMBER FOR 810 PREPROCESSOR |
| SNDPOR | Sender port (SAP System, EDI subsystem) |
| UNAME | User name |
| BELNR | Accounting document number |
| DATUM | Date |
| UZEIT | Time |
| SNDPRN | EDI SENDING PARTNER NUMBER |
| NAME1 | NAME FROM EDI_Z3 RS RECORD |
| VBELN | Vendor's Billing Invoice Number |
| SHKZG | Debit/credit indicator |
| ZOGIV | ORIGINAL GROSS AMOUNT FROM INVOICE |
| ZOTIV | ORIGINAL TAX AMOUNT FROM INVOICE |
| ZCGIV | IDOC GROSS INVOICE AMOUNT |
| ZCTIV | IDOC PROPORTIONED TAX AMOUNT |
| WAERS | Currency Key |
| ZNOID | NUMBER OF IDOCS CREATED |
| MSGID | Message identification |
| MSGTY | Message type |
| MSGNO | System message number |
| MTEXT | MESSAGE TEXT GENERATED DURING 810 |
| | PREPROCESSOR RUN |
| RCVPRN | Partner number of receiver |
| ZDATUM | Date |
| ZUZEIT | Time |
| ZUNAME | User name |
| SNDLAD | Logical address of sender |
| BUKRS | Company Code |
| EBELN | Purchasing Document Number |
| VAL_RULEID | EU VAT validation rule identifier |
| SUPTXLAND1 | Supplier ISO Country key |
| PUR_LAND1 | Purchasing ISO Country key |
| DEL_LAND1 | Ship to ISO Country key |
| REG_NUM906 | Supplier VAT registration number |
| REG_NUM909 | Purchasing company VAT registration number |
| REG_DOM906 | VAT registration number |

8. The method of claim 4 further including the step of creating a log of all received input criteria that have passed through the first validation and are ready for posting within SAP.

9. The method of claim 8 wherein the log is stored in a ZPPOL table.

10. The method of claim 9 wherein the ZPPAL table includes the following fields:

| | |
|---|---|
| ZLGNO | LOG NUMBER FOR 810 EDI PREPROCESSOR |
| | PROGRAMs |
| ZSQNO | SEQUENCE NUMBER FOR 810 PREPROCESSOR |
| EBELN | Purchasing Document Number |
| DOCNUM | IDOC DOCUMENT NUMBER |
| ZIPRO | IDOC PROCESSED FLAG |
| BUKRS | Company Code |
| BELNR | Accounting document number |
| GJAHR | Fiscal year |
| ZDATE | Date |
| ZCGIV | IDOC GROSS INVOICE AMOUNT |
| ZCTIV | IDOC PROPORTIONED TAX AMOUNT |
| WAERS | Currency Key |
| ZDATUM | Date |
| ZUZEIT | Time |
| ZUNAME | User name. |

11. The method of claim 2 wherein the the report can be run based on the following input criteria:
Entry Date;
Log Number;
SAP Company Code;
Vendor number;
Supplier Tax Country (i.e., HU, NL, DE, FR);
Purchasing Tax Country (i.e., HU, NL, DE, FR);
ZPPOL Processing status (D, E, P, R, M, C); and
Flag to include/exclude preprocessor errors.

12. The method of claim 2 wherein the information included in the report includes:
Company Code;
Vendor Number;
Vendor Name;
Supplier Tax Country;
Purchasing Tax Country;
Transaction Type (D=Debit, C=Credit);
Supplier Invoice Number;
Supplier Invoice Date (also called Tax Point Date);
SAP Document Number;
Year;
Invoice Baseline Date;
Gross Amount in Document Currency;
Document Currency Code;
Tax Amount in Document Currency;
Document Currency Code;
Tax Amount in Local Currency;
Local Currency Code;
Log Number;
Sequence Number;
Processing Date/Entry Date;
Purchase Order Number; and
Invoice Processing Status.

13. The method of claim 2 further including the step of allowing drilling into the fields of: SAP Document number;
Purchase Order number; and
Invoice processing status.

14. A computer program product in a computer readable medium for operating in a system comprising a network I/O, a CPU, and one or more databases, for implementing a method for creating a report for a purchaser of products from a supplier in the EU which are assessed VAT and the purchaser wishes to reclaim the assessed VAT, the created report is based on input criteria related to EU VAT transactions, the input criteria are input electronically and includes the following fields:
supplier VAT registration number;
supplier tax country;
purchaser VAT registration number;
purchasing tax country;
tax amount in local currency;
local currency code; and
invoice/tax point date,
the method comprising the steps of receiving the input criteria from the purchaser in the form an electronic invoice VAT report, parsing the input criteria, and creating a report for the purchaser.

15. The computer program product of claim 14 wherein the method is performed in a SAP system.

16. The computer program product of claim 14 wherein the method further includes the step of validating that the report conforms to EU VAT reporting requirements.

17. The computer program product of claim 16 wherein the method further includes the step of creating a log of all received input criteria.

18. The computer program product of claim 17 wherein the log is stored in a ZPPAL table.

19. The computer program product of claim 18 wherein the ZPPAL table includes the following fields:

| | |
|---|---|
| ZLGNO | LOG NUMBER FOR 810 EDI PREPROCESSOR |
| | PROGRAMs |
| ZSQNO | SEQUENCE NUMBER FOR 810 PREPROCESSOR |
| SNDPOR | Sender port (SAP System, EDI subsystem) |
| UNAME | User name |
| BELNR | Accounting document number |
| DATUM | Date |
| UZEIT | Time |
| SNDPRN | EDI SENDING PARTNER NUMBER |
| NAME1 | NAME FROM EDI_Z3 RS RECORD |
| VBELN | Vendor's Billing Invoice Number |
| SHKZG | Debit/credit indicator |
| ZOGIV | ORIGINAL GROSS AMOUNT FROM INVOICE |
| ZOTIV | ORIGINAL TAX AMOUNT FROM INVOICE |
| ZCGIV | IDOC GROSS INVOICE AMOUNT |
| ZCTIV | IDOC PROPORTIONED TAX AMOUNT |
| WAERS | Currency Key |
| ZNOID | NUMBER OF IDOCS CREATED |
| MSGID | Message identification |
| MSGTY | Message type |
| MSGNO | System message number |
| MTEXT | MESSAGE TEXT GENERATED DURING 810 |
| | PREPROCESSOR RUN |
| RCVPRN | Partner number of receiver |
| ZDATUM | Date |
| ZUZEIT | Time |
| ZUNAME | User name |
| SNDLAD | Logical address of sender |
| BUKRS | Company Code |
| EBELN | Purchasing Document Number |
| VAL_RULEID | EU VAT validation rule identifier |
| SUPTXLAND1 | Supplier ISO Country key |
| PUR_LAND1 | Purchasing ISO Country key |
| DEL_LAND1 | Ship to ISO Country key |
| REG_NUM906 | Supplier VAT registration number |
| REG_NUM909 | Purchasing company VAT registration number |
| REG_DOM906 | VAT registration number |

20. The computer program product of claim 16 wherein the method further includes the step of creating a log of all received input criteria that have passed through the first validation and are ready for posting within SAP.

21. The computer program product of claim 20 wherein the log is stored in a ZPPOL table.

22. The computer program product of claim 21 wherein the ZPPAL table includes the following fields:

| | |
|---|---|
| ZLGNO | LOG NUMBER FOR 810 EDI PREPROCESSOR |
| | PROGRAMs |
| ZSQNO | SEQUENCE NUMBER FOR 810 PREPROCESSOR |
| EBELN | Purchasing Document Number |
| DOCNUM | IDOC DOCUMENT NUMBER |
| ZIPRO | IDOC PROCESSED FLAG |
| BUKRS | Company Code |
| BELNR | Accounting document number |
| GJAHR | Fiscal year |
| ZDATE | Date |
| ZCGIV | IDOC GROSS INVOICE AMOUNT |
| ZCTIV | IDOC PROPORTIONED TAX AMOUNT |
| WAERS | Currency Key |
| ZDATUM | Date |
| ZUZEIT | Time |
| ZUNAME | User name. |

23. The computer program product of claim 14 wherein the report can be run based on the following input criteria:
Entry Date;
Log Number;
SAP Company Code;
Vendor number;
Supplier Tax Country (i.e., HU, NL, DE, FR);
Purchasing Tax Country (i.e., HU, NL, DE, FR);
ZPPOL Processing status (D, E, P, R, M, C); and
Flag to include/exclude preprocessor errors.

24. The computer program product of claim 14 wherein the information included in the report includes:
Company Code;
Vendor Number;
Vendor Name;
Supplier Tax Country;
Purchasing Tax Country;
Transaction Type (D=Debit, C=Credit);
Supplier Invoice Number;
Supplier Invoice Date (also called Tax Point Date);
SAP Document Number;
Year;
Invoice Baseline Date;
Gross Amount in Document Currency;
Document Currency Code;
Tax Amount in Document Currency;
Document Currency Code;
Tax Amount in Local Currency;
Local Currency Code;
Log Number;
Sequence Number;
Processing Date/Entry Date;
Purchase Order Number; and
Invoice Processing Status.

25. The computer program product of claim 14 wherein the method further includes the step of allowing drilling into the fields of: SAP Document number;
Purchase Order number; and
Invoice processing status.
